(19) United States
(12) Patent Application Publication
(10) Pub. No.: US 2024/0210743 A1
(43) Pub. Date: Jun. 27, 2024

(54) ELECTRO-OPTIC MODULATOR AND PREPARATION METHOD THEREFOR

(71) Applicant: PICMORE TECHNOLOGY (SUZHOU) LTD., Suzhou (CN)

(72) Inventors: Mengxi JI, Suzhou (CN); Xianyao LI, Suzhou (CN); Yuzhou SUN, Suzhou (CN)

(21) Appl. No.: 18/598,186

(22) Filed: Mar. 7, 2024

Related U.S. Application Data
(63) Continuation of application No. PCT/CN2022/085486, filed on Apr. 7, 2022.

(30) Foreign Application Priority Data
Sep. 10, 2021 (CN) 202111063185.7

(51) Int. Cl. G02F 1/035

(52) U.S. Cl. CPC G02F 1/035; G02F 2202/20

(57) ABSTRACT

A preparation method for an electro-optic modulator includes: providing a base substrate, and forming a waveguide and bottom electrodes on an upper surface of the base substrate; forming a covering dielectric layer and metal electrodes; forming a supporting substrate on an upper surface of the covering dielectric layer; removing the base substrate; providing a lithium niobate thin film, and bonding the lithium niobate thin film to a surface of the covering dielectric layer remote from the supporting substrate, the lithium niobate thin film being located directly below the waveguide.

### CROSS-REFERENCE TO RELATED APPLICATION

This application is a continuation of International Patent Application No. PCT/CN2022/085486, filed on Apr. 7, 2022, which claims priority to Chinese Patent Application No. 202111063185.7, filed on Sep. 10, 2021. All of the foregoing applications are incorporated herein by reference in their entireties.

### TECHNICAL FIELD

The present application relates to the field of optoelectronic technology, and more particularly, to an electro-optic modulator and a preparation method therefor.

### BACKGROUND

At present, a hot topic in research is hybrid integrated electro-optic modulators combining thin-film lithium niobate and silicon optical technology. A common practice is to prepare a lithium niobate waveguide on a wafer that has a silicon waveguide. However, the biggest challenge associated with this type of hybrid integration is how to achieve optical coupling between the lithium niobate waveguide and the silicon optical waveguide. This is because achieving optical coupling between the lithium niobate waveguide and the silicon optical waveguide requires precise alignment between the lithium niobate waveguide and the silicon optical waveguide, and the precise alignment poses stringent requirements on modulator fabrication.

Therefore, it is necessary to provide an electro-optic modulator capable of solving the above problem of difficult optical coupling between the lithium niobate waveguide and silicon optical waveguide in the electro-optic modulators in the background art.

### SUMMARY

One aspect of the present disclosure provides a preparation method for an electro-optic modulator, comprising steps of:
providing a base substrate, and forming a waveguide and bottom electrodes on an upper surface of the base substrate, the bottom electrodes being located on two opposite sides of the waveguide and spaced apart from the waveguide;
forming a covering dielectric layer and metal electrodes, the covering dielectric layer being located on the upper surface of the base substrate and covering the waveguide and the bottom electrodes, the metal electrodes being located in the covering dielectric layer and on the bottom electrode, and the metal electrodes respectively corresponding to, and being connected to, the bottom electrodes;
forming a supporting substrate on an upper surface of the covering dielectric layer;
removing the base substrate; and
providing a lithium niobate thin film and bonding the lithium niobate thin film to a lower surface of the covering dielectric layer remote from the supporting substrate; the lithium niobate thin film being located directly below the waveguide.

In the preparation method for an electro-optic modulator in the above embodiment, by means of bonding the lithium niobate thin film to an optoelectronic chip that has a waveguide, it is unnecessary to pattern the lithium niobate thin film into a lithium niobate waveguide; light can be self-aligned in the waveguide and the lithium niobate thin film, and therefore no coupling is needed. At the same time, since the metal electrodes are prepared in the optoelectronic chip, the metal electrodes in the optoelectronic chip can be used as electrodes of the electro-optic modulator. Therefore, there is no need for an additional metal deposition process to prepare electrodes of the electro-optic modulator, thus simplifying the process steps and saving costs.

In one embodiment, the step of providing the base substrate and forming the waveguide and the bottom electrodes on the upper surface of the base substrate includes steps of:
providing a silicon-on-insulator (SOI) substrate, the SOI substrate including a back substrate, a buried oxide layer, and a top silicon layer stacked in a bottom-to-top order;
etching the top silicon layer of the SOI substrate to form the waveguide and initial bottom electrodes, the buried oxide layer and the back substrate together constituting the substrate; and
doping the initial bottom electrodes to form the bottom electrodes, the bottom electrodes being heavily doped silicon electrodes.

In one embodiment, the step of providing the lithium niobate thin film and bonding the lithium niobate thin film to the lower surface of the covering dielectric layer remote from the supporting substrate includes steps of:
providing a bonding substrate, the bonding substrate having a first dielectric layer formed thereon;
forming the lithium niobate thin film on an upper surface of the first dielectric layer; and
bonding the lithium niobate thin film to the lower surface of the covering dielectric layer remote from the supporting substrate via a bonding layer.

In one embodiment, the bonding layer includes a benzocyclobutene (BCB) layer.

In one embodiment, before the step of providing a lithium niobate thin film and bonding the lithium niobate thin film to the lower surface of the covering dielectric layer remote from the supporting substrate, the preparation method further includes steps of:
forming a second dielectric layer and a conductive lead-out structure, the second dielectric layer being located on the lower surface of the covering dielectric layer remote from the supporting substrate, and the conductive lead-out structure being connected to the metal electrodes to electrically lead the metal electrodes out, the second dielectric layer having a first opening, the first opening exposing the waveguide, portions of the bottom electrodes, and a portion of the lower surface of the covering dielectric layer;
the lithium niobate thin film being bonded to the lower surface of the covering dielectric layer exposed by the first opening remote from the supporting substrate.

In one embodiment, the step of forming the second dielectric layer and the conductive lead-out structure includes:
forming the second dielectric layer on the exposed lower surface of the covering dielectric layer remote from the supporting substrate, forming interconnect holes in the second dielectric layer and the covering dielectric layer, the interconnect holes respectively corresponding to, and exposing, the metal electrodes;
forming first interconnect plugs in respectively corresponding interconnect holes, each first interconnect plugs having one end connected to a corresponding metal electrode; and
forming backside electrodes on a surface of the second dielectric layer remote from the covering dielectric layer, the backside electrodes respectively corresponding to, and being connected to, the first interconnect plugs, the backside electrodes and the first interconnect plugs together constituting the conductive lead-out structure.

In one embodiment, the step of forming the second dielectric layer and the conductive lead-out structure includes:
forming the second dielectric layer on the exposed lower surface of the covering dielectric layer remote from the supporting substrate, forming first interconnect plugs in the second dielectric layer and the covering dielectric layer, and forming backside electrodes in the second dielectric layer, the first interconnect plugs respectively corresponding to the metal electrodes, the backside electrodes respectively corresponding to the first interconnect plugs, each of the first interconnect plugs having one end connected to a corresponding metal electrode and another end connected to a corresponding backside electrode, the backside electrodes and the first interconnect plugs together constituting the conductive lead-out structure; and
forming the first opening and second openings in the second dielectric layer, the second openings respectively corresponding to, and exposing, the backside electrodes.

In one embodiment, each of the backside electrodes includes a plurality of backside electrode metal layers and a plurality of second interconnect plugs. The backside electrode metal layers that are adjacent are connected by the second interconnect plugs. Each second opening exposes a backside electrode metal layer located at the bottom of a corresponding backside electrode. Any of the backside electrode metal layers in one of the backside electrodes is connected to a corresponding metal electrode by one of the first interconnect plugs.

The present disclosure further provides an electro-optic modulator, including:
a lithium niobate thin film;
a covering dielectric layer located on the lithium niobate thin film;
a waveguide located in the covering dielectric layer and directly above the lithium niobate thin film;
bottom electrodes located in the covering dielectric layer and on two opposite sides of the waveguide and spaced apart from the waveguide; and
metal electrodes located in the covering dielectric layer and on the bottom electrodes, the metal electrodes respectively corresponding to, and connected to, the bottom electrodes.

In the electro-optic modulator in the above embodiment, a lithium niobate thin film is bonded to an optoelectronic that has a waveguide. Therefore, it is unnecessary to pattern the lithium niobate thin film into a lithium niobate waveguide, and light can be self-aligned in the waveguide and the lithium niobate thin film, therefore no coupling is needed. At the same time, since the metal electrodes are prepared in the optoelectronic chip, the metal electrode in the optoelectronic chip can be used as an electrode of the electro-optic modulator. Therefore, there is no need for an additional metal deposition process to prepare an electrode of the electro-optic modulator, thus simplifying the process steps and saving costs.

In one embodiment, the electro-optic modulator further includes:
a supporting substrate located on an upper surface of the covering dielectric layer remote from the lithium niobate thin film;
a first dielectric layer located on a surface of the lithium niobate thin film remote from the covering dielectric layer; and
a bonding substrate located on a surface of the first dielectric layer remote from the lithium niobate thin film.

In one embodiment, the electro-optic modulator further includes:
a second dielectric layer located on a lower surface of the covering dielectric layer remote from the supporting substrate, the second dielectric layer having a first opening, the first opening exposing the waveguide, portions of the bottom electrodes, and a portion of the covering dielectric layer, the lithium niobate thin film being located in the first opening.

In one embodiment, the lithium niobate thin film and the covering dielectric layer are combined together by way of bonding.

In one embodiment, the electro-optic modulator further includes a plurality of the bottom electrodes, a plurality of the metal electrodes, and a plurality of the waveguides, the waveguides being located between the metal electrodes that are adjacent, projections of all of the waveguides onto a plane in which the lithium niobate thin film is located are on a surface of the lithium niobate thin film facing the covering dielectric layer.

### ADVANTAGEOUS EFFECTS

The electro-optic modulator proposed by the present disclosure can solve the problem of difficult optical coupling between a lithium niobate waveguide and a silicon optical waveguide.

### BRIEF DESCRIPTION OF DRAWINGS

In order to more clearly illustrate the technical solutions of the embodiments of the present disclosure, the drawings used in the description of the embodiments are briefly introduced below. Obviously, the drawings described below are only some of the embodiments of the present disclosure; for persons of ordinary skill in the art, drawings of other embodiments can be obtained based on these drawings without creative work.

FIG. 1 is a flow chart of a preparation method for an electro-optic modulator according to a first embodiment of the present disclosure.

FIGS. 2 through 9 are schematic sectional views of structures resulting from various steps in the preparation method for the electro-optic modulator according to the first embodiment of the present disclosure.

FIG. 10 is a schematic sectional view of a structure that results after first interconnect plugs and backside electrodes are formed in a preparation method for an electro-optic modulator according to a second embodiment of the present disclosure.

FIG. 11 is a schematic sectional view of a structure that resulted after a lithium niobate thin film is formed in a preparation method for an electro-optic modulator according to the second embodiment of the present disclosure.

FIG. 12 is a schematic sectional view of a structure that resulted after first interconnect plugs and backside electrodes are formed in a preparation method for an electro-optic modulator according to a third embodiment of the present disclosure.

FIG. 13 is a schematic sectional view of a structure that resulted after a lithium niobate thin film is formed in a preparation method for an electro-optic modulator according to the third embodiment of the present disclosure.

FIG. 14 is a top-view schematic structural diagram of an electro-optic modulator resulting from a preparation method for an electro-optic modulator according to a fourth embodiment of the present disclosure.

FIG. 15 is a sectional-view schematic structural diagram of the electro-optic modulator of FIG. 14 along an A-A′ line direction in FIG. 14.

DESCRIPTION OF REFERENCE NUMERALS IN THE DRAWINGS

11: SOI substrate; 110: substrate; 111: back substrate; 112: buried oxide layer; 113: top silicon layer; 1131: waveguide; 1132: initial bottom electrode; 1133: bottom electrode; 12: covering dielectric layer; 13: metal electrode; 131: metal layer; 132: conductive plug; 14: supporting substrate; 15: lithium niobate thin film; 16: bonding layer; 17: first dielectric layer; 18: bonding substrate; 19: second dielectric layer; 191: first opening; 192: second opening; 20: first interconnect plug; 21: backside electrode; 211: backside electrode metal layer; 212: second interconnect plug.

### DETAILED DESCRIPTION

In order to facilitate understanding of the disclosure, a more comprehensive description of the disclosure will be provided below with reference to the relevant accompanying drawings. The accompanying drawings show embodiments of the present disclosure. However, the present disclosure can be implemented in many different forms and is not limited by the embodiments described herein. Rather, these embodiments are provided to make the disclosure of the present disclosure more thorough and comprehensive.

Unless otherwise defined, all technical and scientific terms used herein have the same meaning as commonly understood by persons of skill in the art of the present disclosure. The terminology used herein in the specification of the present disclosure is for the purpose of describing specific embodiments only and is not intended to limit the present disclosure.

It can be understood that the terms “first,” “second,” “third,” “fourth,” etc. as used in the present disclosure may be used herein to describe various components, but these components are not limited by these terms. These terms are used only to distinguish a first component from another component. By way of example, without departing from the scope of the present disclosure, a first control device may be referred to as a second control device, and similarly, a second control device may be referred to as a first control device. Both the first control device and the second control device are control devices, but they are not the same control device.

It can be understood that “connection” in the following embodiments is understood to mean “electrical connection,” “communication connection,” etc., if electrical signals or data are transmitted between the connected circuits, modules, units, etc.

When used herein, singular forms indicated by “one,” “a/an,” and “said/the” may also include plural forms, unless the context clearly indicates otherwise. It should also be understood that the terms “comprise/include” or “have” indicate the presence of a stated feature, ensemble, step, operation, portion, part, or a combination thereof, but do not exclude the possibility of the presence or addition of one or more other features, ensembles, steps, operations, portions, parts, or combinations thereof. And, the term “and/or” as used in the specification includes any and all combinations of the items in the list.

### Embodiment 1

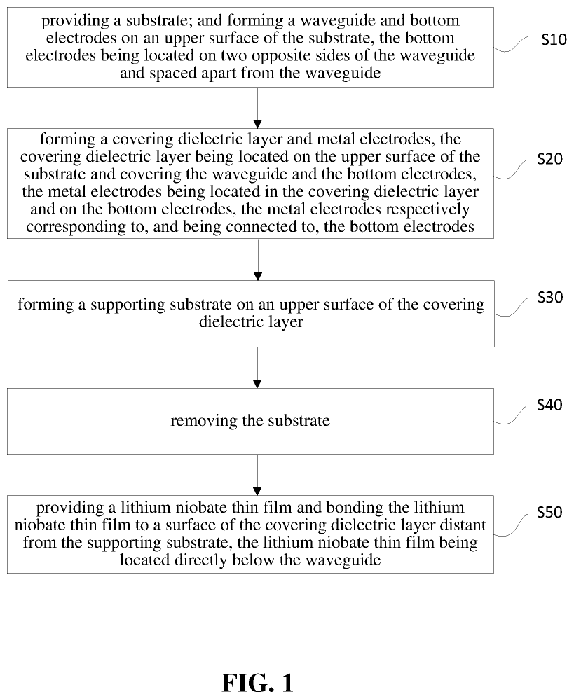

FIG. 1 is a flow chart of a preparation method for an electro-optic modulator according to a first embodiment of the present disclosure. Referring to FIG. 1, a preparation method for an electro-optic modulator according the first embodiment includes:
S10: providing a substrate; and forming a waveguide and bottom electrodes on an upper surface of the substrate, the bottom electrodes being located on two opposite sides of the waveguide and spaced apart from the waveguide;
S20: forming a covering dielectric layer and metal electrodes, the covering dielectric layer being located on the upper surface of the substrate and covering the waveguide and the bottom electrodes, the metal electrodes being located in the covering dielectric layer and on the bottom electrodes, the metal electrodes respectively corresponding to, and being connected to, the bottom electrodes;
S30: forming a supporting substrate on an upper surface of the covering dielectric layer;
S40: removing the substrate; and
S50: providing a lithium niobate thin film and bonding the lithium niobate thin film to a lower surface of the covering dielectric layer remote from the supporting substrate, the lithium niobate thin film being located directly below the waveguide.

In the preparation method for an electro-optic modulator in the first embodiment, by means of bonding the lithium niobate thin film to an optoelectronic chip that has the waveguide, it is unnecessary to pattern the lithium niobate thin film into a lithium niobate waveguide. Light can be self-aligned in the waveguide and the lithium niobate thin film, and therefore no coupling is needed. At the same time, since the metal electrodes are prepared in the optoelectronic chip, the metal electrodes in the optoelectronic chip can be used as electrodes of the electro-optic modulator. Therefore, there is no need for an additional metal deposition process to prepare electrodes of the electro-optic modulator, thus simplifying the process steps and saving costs.

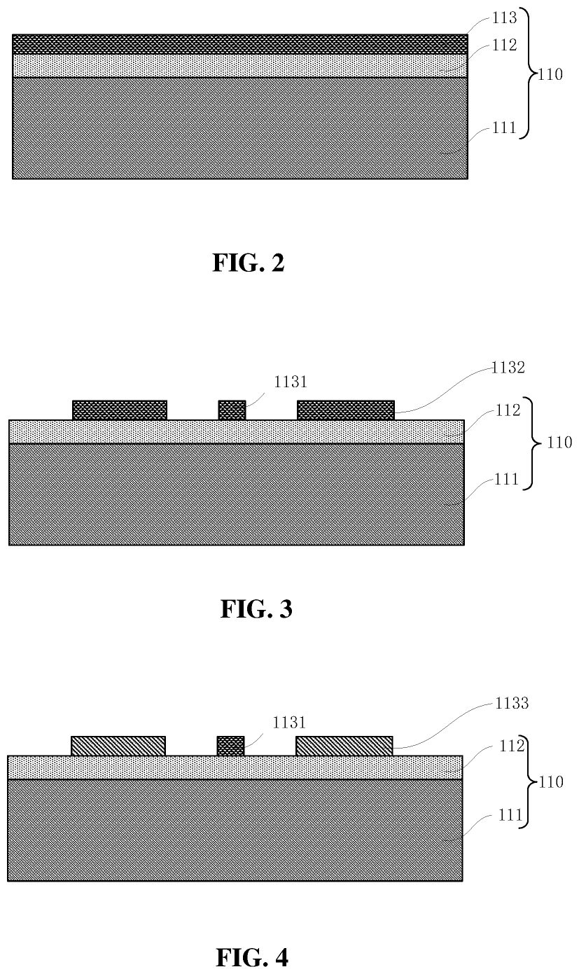

FIGS. 2 through 9 are schematic sectional views of structures resulting from various steps in the preparation method for the electro-optic modulator according to the first embodiment of the present disclosure. In step S10, referring to step S10 in FIG. 1 and to FIGS. 2 to 4, a base substrate 110 is provided, and a waveguide 1131 and bottom electrodes 1133 are formed on an upper surface of the base substrate 110. The bottom electrodes 1133 are located on two opposite sides of the waveguide 1131 and spaced apart from the waveguide 1131.

According to an embodiment, step S10 may include the following steps:
S101: providing a silicon-on-insulator (SOI) substrate 110, the SOI substrate 110 including a back substrate 111, a buried oxide layer 112, and a top silicon layer 113 stacked in a bottom-to-top order as shown in FIG. 2;
S102: etching the top silicon layer 113 of the SOI substrate 110 to form the waveguide 1131 and initial bottom electrodes 1132, as shown in FIG. 3. Specifically, the etching of the top silicon layer 113 may use, but is not limited to, a dry etching process. The buried oxide layer 112 and the back substrate 111 together constitute the base substrate 110; and
S103: doping the initial bottom electrodes 1132 to form the bottom electrodes 1133, as shown in FIG. 4. The bottom electrodes 1133 may be heavily doped silicon electrodes (e.g., a concentration of dopant being greater than 10¹⁸/cm³).

According to an embodiment, a spacing between the bottom electrodes 1133 and the waveguide 1131 may be configured according to actual needs. For example, the spacing between the bottom electrodes 1133 and the waveguide 1131 may be in the range of, but is not limited to, 500 nm to 5000 nm. Specifically, the spacing between the bottom electrodes 1133 and the waveguide 1131 may be 500 nm, 1000 nm, 2000 nm, 3000 nm, 4000 nm, or 5000 nm, etc.

According to the embodiments of the present disclosure, by using a doped silicon electrode as the bottom electrodes 1133, an electric field generated by the doped silicon electrode can realize electro-optic modulation. The spacing between the bottom electrodes 1133 and the waveguide 1131 cannot be too far or too close. If the bottom electrodes 1133 are too close to the waveguide 1131 (e.g., less than 500 nm), the bottom electrodes 1133 will absorb an optical field, resulting in a higher optical loss. However, if the bottom electrodes 1133 are too far from the waveguide 1131 (e.g., greater than 5000 nm), the electro-optic modulation realized by the electric field generated by the bottom electrodes 1133 will be less effective. By limiting the spacing between the bottom electrodes 1133 and the waveguide 1131 to 500 nm to 5000 nm, a better electro-optic modulation efficiency may be achieved while ensuring a lower optical loss.

In step S20, referring to step S20 in FIG. 1 and to FIG. 5, a covering dielectric layer 12 and metal electrodes 13 are formed. The covering dielectric layer 12 is located on an upper surface of the buried oxide layer 112 and covers the waveguide 1131 and the bottom electrodes 1133. The metal electrodes 13 are located within the covering dielectric layer 12. The metal electrodes 13 correspond to the bottom electrodes 1133. The metal electrodes 13 are located on, and connected to, the respectively corresponding bottom electrodes 1133.

According to one embodiment, each metal electrode 13 may be a monolayer electrode formed as a single metal layer.

According to another embodiment, each metal electrode 13 may be a stacked metal electrode and may include a plurality of metal layers 131 and a plurality of conductive plugs 132. A bottom-most metal layer 131 (the metal layer 131 at the bottom of each metal electrode 13) and the corresponding bottom electrode 1133 are connected by one of the conductive plugs 132. The adjacent metal layers 131 are also connected by the conductive plugs 132.

According to an embodiment, each conductive plug 132 may be a metal plug. Specifically, each conductive plug 132 may include, but is not limited to, an aluminum plug, a copper plug, a nickel plug, or a titanium plug, etc. Each metal layer 131 may include a copper layer, a nickel layer, an aluminum layer, or a titanium layer, etc.

According to an embodiment, the upper surface of the covering dielectric layer 12 may be higher than upper surfaces of the metal electrodes 13, and the covering dielectric layer 12 may serve to cover and protect the metal electrodes 13.

According to an embodiment, the covering dielectric layer 12 may include, but is not limited to, an oxide layer. Specifically, the covering dielectric layer 12 may include, but is not limited to, a silicon oxide layer.

According to an embodiment, when each metal electrode 13 is a stacked metal electrode, the covering dielectric layer 12 may include a plurality of stacked sub dielectric layers (not shown). The method for forming the covering dielectric layer 12 and the metal electrodes 13 may be: first, a sub dielectric layer is formed on an upper surface of the buried oxide layer 112, an interconnect via is formed in the sub dielectric layer, and a bottom-most conductive plug 132 is formed in the interconnect via; next, a bottom-most metal layer 131 is formed on an upper surface of the formed sub dielectric layer; then, another sub dielectric layer is formed on the upper surface of the formed sub dielectric layer, an interconnect via is formed in this sub dielectric layer, and a conductive plug 132 is formed in the interconnect via; after that, another metal layer 131 is formed on an upper surface of the formed sub dielectric layer; and the above steps are repeated a number of times until the covering dielectric layer 12 and the metal electrodes 13 are formed.

In step S30, referring to step S30 in FIG. 1 and to FIG. 6, a supporting substrate 14 is formed on the upper surface of the covering dielectric layer 12.

Specifically, the supporting substrate 14 may be any kind of substrate that can play a supporting role, such as a silicon substrate, a glass substrate, or a sapphire substrate, etc.

According to an embodiment, the supporting substrate 14 may be combined with the upper surface of the covering dielectric layer 12 by, but is not limited to, a bonding process.

In step S40, referring to step S40 in FIG. 1 and to FIG. 7, the base substrate 110 is removed.

Specifically, the back substrate 111 and the buried oxide layer 112 of the base substrate 110 may be sequentially removed by, but is not limited to, a polishing process. After the removal, a bottom of the covering dielectric layer 12, bottoms of the bottom electrodes 1133, and a bottom of the waveguide 1131 are exposed.

In step S50, referring to step S50 in FIG. 1 and to FIGS. 8 and 9, a lithium niobate thin film 15 is provided, and the lithium niobate thin film 15 is bonded to the lower surface of the covering dielectric layer 12 remote from the supporting substrate 14. The lithium niobate thin film 15 is located directly below the waveguide 1131.

According to an embodiment, providing the lithium niobate thin film 15 and bonding the lithium niobate thin film 15 to the lower surface of the covering dielectric layer 12 remote from the supporting substrate 14 may include:
providing a bonding substrate 18, the bonding substrate 18 having a first dielectric layer 17 formed thereon; the bonding substrate 18 may include any kind of substrate, such as a silicon substrate, a sapphire substrate, a glass substrate, or a gallium nitride substrate, etc.; the first dielectric layer 17 may include, but is not limited to, a silicon oxide layer;
forming a lithium niobate thin film 15 on an upper surface of the first dielectric layer 17; specifically, the lithium niobate thin film 15 may be bonded to the upper surface of the first dielectric layer 17 by, but is not limited to, a bonding process; and
bonding the lithium niobate thin film 15 to the lower surface of the covering dielectric layer 12 remote from the supporting substrate 14 via a bonding layer 16. In other embodiments, the lithium niobate thin film 15 may, alternatively, be directly bonded to the covering dielectric layer 12; in other words, the bonding layer 16 may be omitted.

According to an embodiment, the bonding layer 16 may include, but is not limited to, a BCB (benzocyclobutene) layer. According to another embodiment, the bonding layer 16 may include a silicon oxide layer.

Specifically, the bonding layer 16 may be combined with the covering dielectric layer 12 by adhesive forces or intermolecular forces.

According to an embodiment, providing the lithium niobate thin film 15 and bonding the lithium niobate thin film 15 to the lower surface of the covering dielectric layer 12 remote from the supporting substrate 14, may also include:
forming a second dielectric layer 19 and a conductive lead-out structure (not shown), the second dielectric layer 19 being located on the lower surface of the covering dielectric layer 12 remote from the supporting substrate 14, and the conductive lead-out structure being connected to the metal electrodes 13 to electrically lead the metal electrodes 13 out; the second dielectric layer 19 having a first opening 191, the first opening 191 exposing the waveguide 1131, portions of the bottom electrodes 1133, and a portion of the covering dielectric layer 12, as shown in FIG. 8; specifically, the first opening 191 may be formed by, but is not limited to, a dry etching process; and
bonding the lithium niobate thin film 15 to the lower surface of the covering dielectric layer 12 exposed by the first opening 191 remote from the supporting substrate 14, as shown in FIG. 9.

Specifically, the conductive lead-out structure may include metal plugs that extend through the supporting substrate 14 and are connected to the respectively corresponding metal electrodes 13.

Continuing to refer to FIG. 9 in conjunction with FIGS. 2 through 8, the present disclosure also provides an electro-optic modulator, the electro-optic modulator including: a lithium niobate film 15; a covering dielectric layer 12 located on the lithium niobate thin film 15; a waveguide 1131, the waveguide 1131 being located in the covering dielectric layer 12 and directly above the lithium niobate thin film 15; bottom electrodes 1133, the bottom electrodes 1133 being located in the covering dielectric layer 12 and on two opposite sides of the waveguide 1131 and spaced apart from the waveguide 1131; and metal electrodes 13, the metal electrodes 13 being located in the covering dielectric layer 12 and on respectively corresponding bottom electrodes 1133 and being connected to the respectively corresponding bottom electrodes 1133.

According to one embodiment, each metal electrode 13 may be a monolayer electrode formed as a single metal layer.

According to another embodiment, each metal electrode 13 may be a stacked metal electrode, and may include a plurality of metal layers 131 and a plurality of conductive plugs 132. A bottom-most metal layer 131 and the corresponding bottom electrode 1133 of each metal electrode 13 are connected by one of the conductive plugs 132. The adjacent metal layers 131 are also connected by the conductive plugs 132.

In the electro-optic modulator formed according to the first embodiment, the lithium niobate thin film 15 is bonded to an optoelectronic chip that has the waveguide 1131. Therefore, it is unnecessary to pattern the lithium niobate thin film 15 into a lithium niobate waveguide, and light can be self-aligned in the waveguide 1131 and the lithium niobate thin film 15, therefore no coupling is needed. At the same time, since the metal electrodes are prepared in the optoelectronic chip, the metal electrodes 13 in the optoelectronic chip can be used as an electrode of the electro-optic modulator. Therefore, there is no need for an additional metal deposition process to prepare an electrode of the electro-optic modulator, thus simplifying the process steps and saving costs.

According to embodiments of the present disclosure, the spacing between the bottom electrode 1133 and the waveguide 1131 may be configured according to actual needs. For example, the spacing between the bottom electrode 1133 and the waveguide 1131 may be in the range of, but is not limited to, 500 nm to 5000 nm. Specifically, the spacing between the bottom electrode 1133 and the waveguide 1131 may be 500 nm, 1000 nm, 2000 nm, 3000 nm, 4000 nm, or 5000 nm, etc.

According to embodiments of the present disclosure, by using a doped silicon electrode as the bottom electrode 1133, the electric field generated by the doped silicon electrode can realize electro-optic modulation. The spacing between the bottom electrodes 1133 and the waveguide 1131 cannot be too far or too close. If the bottom electrodes 1133 are too close to the waveguide 1131 (e.g., less than 500 nm), the bottom electrodes 1133 will absorb an optical field, resulting in a higher optical loss. However, if the bottom electrodes 1133 are too far from the waveguide 1131 (e.g., greater than 5000 nm), the electro-optic modulation realized by the electric field generated by the bottom electrodes 1133 will be less effective. By limiting the spacing between the bottom electrodes 1133 and the waveguide 1131 to 500 nm to 5000 nm, a better electro-optic modulation efficiency may be achieved while ensuring a lower optical loss.

According to an embodiment, each conductive plug 132 may be a metal plug. Specifically, each conductive plug 132 may include, but is not limited to, an aluminum plug, a copper plug, a nickel plug, or a titanium plug, etc. Each metal layer 131 may include a copper layer, a nickel layer, an aluminum layer, or a titanium layer, etc.

According to an embodiment, an upper surface of the covering dielectric layer 12 may be higher than upper surfaces of the metal electrodes 13, and the covering dielectric layer 12 may serve to cover and protect the metal electrodes 13.

According to an embodiment, the covering dielectric layer 12 may include, but is not limited to, an oxide layer. Specifically, the covering dielectric layer 12 may include, but is not limited to, a silicon oxide layer.

According to an embodiment, the covering dielectric layer 12 may include a plurality of stacked sub dielectric layers (not shown).

According to an embodiment, the electro-optic modulator may further include: a supporting substrate 14, the supporting substrate 14 being located on a lower surface of the covering dielectric layer 12 remote from the lithium niobate thin film 15; a first dielectric layer 17, the first dielectric layer 17 being located on a surface of the lithium niobate thin film 15 remote from the covering dielectric layer 12; and a bonding substrate 18, the bonding substrate 18 being located on a surface of the first dielectric layer 17 remote from the lithium niobate thin film 15.

Specifically, the supporting substrate 14 may be any kind of substrate that can play a supporting role, such as a silicon substrate, a glass substrate, or a sapphire substrate, etc.

According to an embodiment, the bonding substrate 18 may include any kind of substrate, such as a silicon substrate, a sapphire substrate, a glass substrate, or a gallium nitride substrate, etc. The first dielectric layer 17 may include, but is not limited to, a silicon oxide layer.

According to an embodiment, the lithium niobate thin film 15 is bonded to the lower surface of the covering dielectric layer 12 via a bonding layer 16. For example, the bonding layer 16 may include, but is not limited to, a BCB layer. In other examples, the bonding layer 16 may include a silicon oxide layer.

According to an embodiment, the electro-optic modulator may further include: a second dielectric layer 19, the second dielectric layer 19 being located on the lower surface of the covering dielectric layer 12 remote from the supporting substrate 14. The second dielectric layer 19 has a first opening 191, the first opening 191 exposing the waveguide 1131, portions of the bottom electrodes 1133, and a portion of the covering dielectric layer 12. The lithium niobate thin film 15 is located in the first opening 191.

According to an embodiment, the lithium niobate thin film 15 may be bonded to the covering dielectric layer 12 by a bonding process.

According to an embodiment, the electro-optic modulator may also include a conductive lead-out structure (not shown), and the conductive lead-out structure is connected to the metal electrodes 13 to electrically lead the metal electrodes 13 out.

Further, in the first embodiment, the conductive lead-out structure may include metal plugs that extend through the supporting substrate 14 and are connected to the respectively corresponding metal electrodes 13.

### Embodiment 2

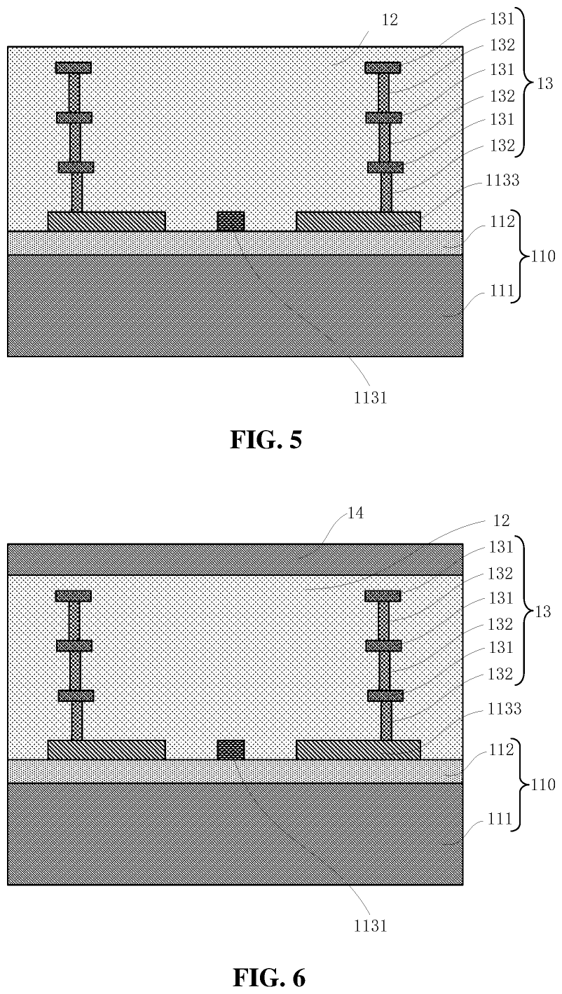

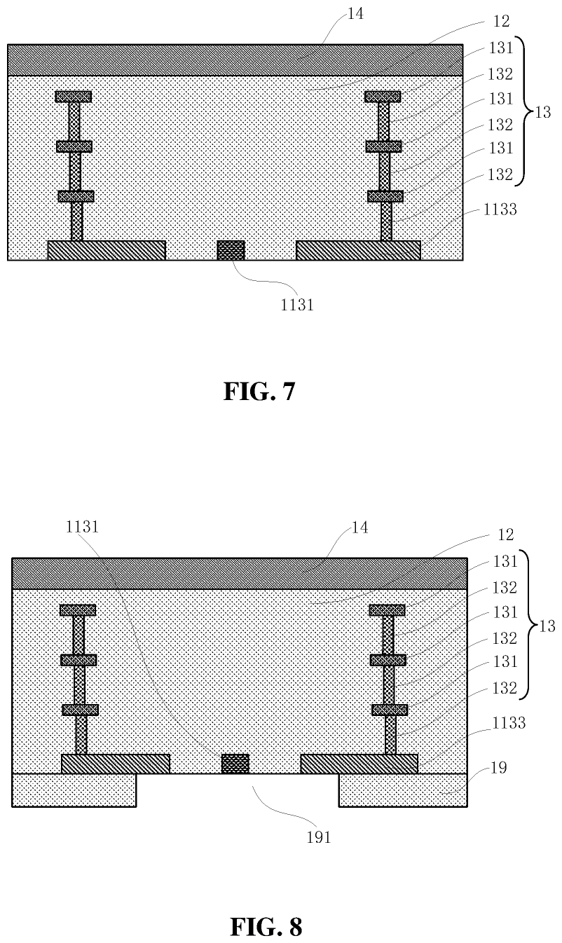

FIGS. 10 and 11 are schematic sectional views of structures resulting from various steps in a preparation method for an electro-optic modulator according to a second embodiment of the present disclosure. Referring to FIGS. 10 and 11 in conjunction with FIGS. 1 through 9, the second embodiment of the present disclosure provides another preparation method for an electro-optic modulator. The preparation method for the electro-optic modulator of the second embodiment is largely the same as the preparation method for the electro-optic modulator provided in the first embodiment, wherein the bottom electrode 1133 and the metal electrode 13 together constitute a front electrode. The methods of the first and second embodiments differ primarily in the preparation method for the second dielectric layer 19 and a conductive lead-out structure. Specifically, according to the second embodiment, the preparation method for the second dielectric layer 19 and the conductive lead-out structure includes:
forming second dielectric layer 19 on the lower surface of the covering dielectric layer 12 remote from the supporting substrate 14;
forming interconnect holes (not shown) in the second dielectric layer 19 and the covering dielectric layer 12, the interconnect holes respectively corresponding to the metal electrodes 13, and each interconnect hole exposing one of the metal layers 131 in a corresponding stacked metal electrode 113; specifically, each interconnect hole may expose the bottom-most metal layer 131 in the corresponding stacked metal electrode 113, or expose the metal layer 131 next to the bottom-most metal layer 131 in the corresponding metal electrode 13, or expose any of the other metal layers 131 in the corresponding metal electrode 13;
forming first interconnect plugs 20 in the interconnect holes, and forming backside electrodes 21 in the second dielectric layer 19; each first interconnect plug 20 having one end connected to a corresponding backside electrode 21 and another end connected to a corresponding metal electrode 13; when each metal electrode 13 is a stacked metal electrode, each first interconnect plug 20 may be connected to any metal layer 113 in the corresponding metal electrode 13, i.e., the first interconnect plug 20 may be connected to the bottom-most metal layer 131 in the corresponding stacked metal electrode 113, or to the metal layer 131 next to the bottom-most metal layer 131 in the corresponding metal electrode 13, or to any of the other metal layers 131 in the corresponding metal electrode 13; the backside electrodes 21 and the first interconnect plugs 20 together constituting the conductive lead-out structure; and
forming the first opening 191 and second openings 192 in the second dielectric layer 19, each second opening 192 exposing a corresponding backside electrode 21, as shown in FIG. 10.

According to an embodiment, as shown in FIGS. 10 and 11, each backside electrode 21 may include a plurality of backside electrode metal layers 211 and a plurality of second interconnect plugs 212. The backside electrode metal layers 211 that are adjacent are connected by the second interconnect plugs 212. Each second opening 192 exposes the bottom-most backside electrode metal layer 211 of the corresponding backside electrode 21. Any of the backside electrode metal layers 211 in the backside electrodes 21 is connected to any of the metal layers 131 in the corresponding metal electrodes 13 by the first interconnect plugs 20.

Continuing to refer to FIG. 11, the second embodiment provides another electro-optic modulator. The specific structure of the electro-optic modulator of the second embodiment is largely the same as the specific structure of the electro-optic modulator of the first embodiment, except that the conductive lead-out structure in the electro-optic modulator in the second embodiment is different from the conductive lead-out structure of the electro-optic modulator in first embodiment. In the first embodiment, the electro-optic modulator only includes the front electrode constituted by the bottom electrodes 1133 and the metal electrodes 13, and the conductive lead-out structure is connected to the metal electrodes 13 to electrically lead the metal electrodes 13 out. In contrast, in the second embodiment, the conductive lead-out structure includes: the backside electrodes 21, the backside electrodes 21 being located in the second dielectric layer 19; the first interconnect plugs 20, each first interconnect plug 20 having one end connected to the corresponding backside electrode 21 and another end connected to the corresponding metal electrode 13; the second dielectric layer 19 also having the second openings 192, each second opening 192 exposing the corresponding backside electrode 21.

Specifically, when each metal electrode 13 is a stacked metal electrode, each first interconnect plug 20 may be connected to any metal layer 113 in the corresponding metal electrode 13. That is, each first interconnect plug 20 may be connected to the bottom-most metal layer 131 in the corresponding stacked metal electrode 13, or to the metal layer 131 next to the bottom-most metal layer 131 in the corresponding metal electrode 13, or to any of the other metal layers 131 in the corresponding metal electrode 13. The backside electrodes 21 and the first interconnect plugs 20 together constitute the conductive lead-out structure.

According to an embodiment, each backside electrode 21 may include a plurality of backside electrode metal layers 211 and a plurality of second interconnect plugs 212. The backside electrode metal layers 211 that are adjacent are connected by the second interconnect plugs 212. Each of the second openings 192 exposes the bottom-most backside electrode metal layer 211 in the corresponding back side electrode 21. Any of the backside electrode metal layers 211 in the backside electrodes 21 is connected to the metal electrode 13 by the corresponding first interconnect plugs 20.

### Embodiment 3

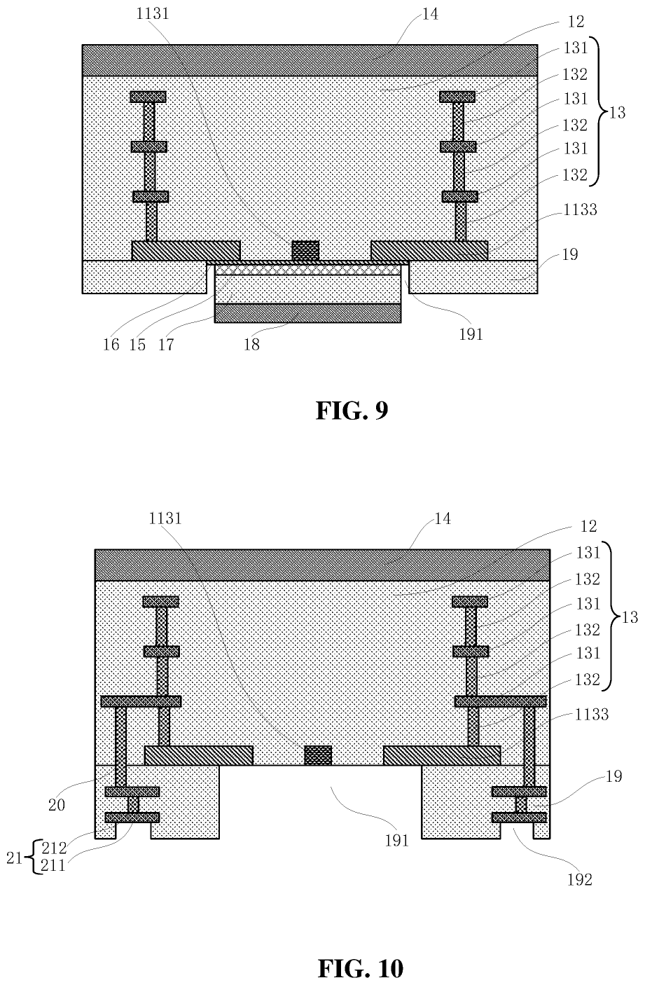

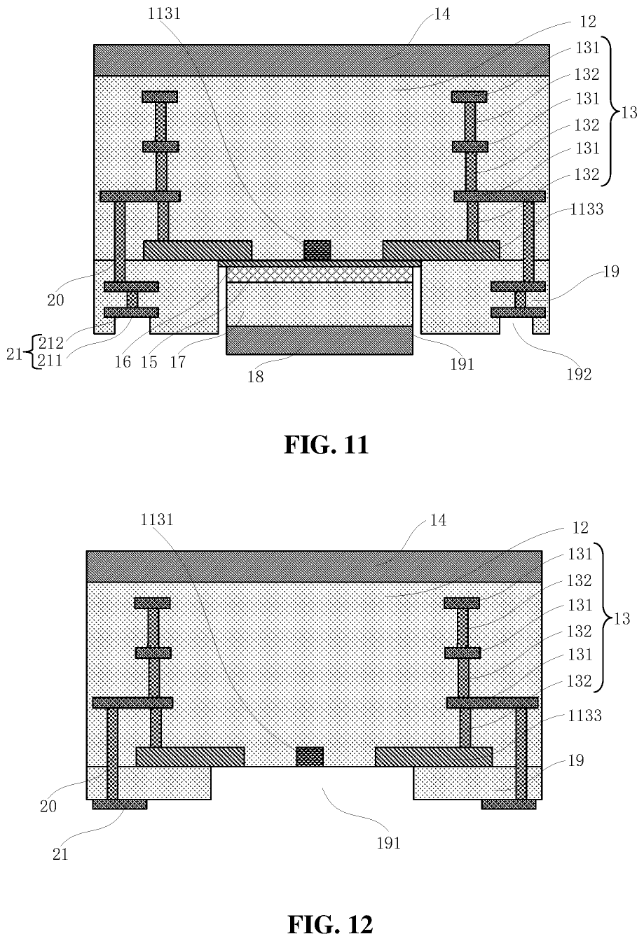

FIGS. 12 and 13 are schematic sectional views of structures resulting from various steps in a preparation method for an electro-optic modulator according to a third embodiment of the present disclosure. Referring to FIGS. 12 and 13 in conjunction with FIGS. 1 through 9, the third embodiment of the present disclosure provides another preparation method for an electro-optic modulator. The preparation method for the electro-optic modulator of the third embodiment is largely the same as the preparation method for the electro-optic modulator of the first embodiment, wherein the bottom electrode 1133 and the metal electrode 13 together constitute a front electrode. The methods of the first and third embodiments differ primarily in the preparation method for the second dielectric layer 19 and the conductive lead-out structure. According to the third embodiment, the preparation method for the second dielectric layer 19 and the conductive lead-out structure includes:
forming a second dielectric layer 19 on the lower surface of the covering dielectric layer 12 remote from the supporting substrate 14; forming interconnect holes (not shown) in the second dielectric layer 19 and the covering dielectric layer 12, each interconnect hole exposing a correspond metal electrode 13;
forming first interconnect plugs 20 in the interconnect holes, each first interconnect plug 20 having one end connected to the corresponding metal electrode 13; and
forming backside electrodes 21 on a surface of the second dielectric layer 19 remote from the covering dielectric layer 12, each backside electrode 21 being connected to a corresponding first interconnect plug 20, as shown in FIG. 12; the backside electrodes 21 and the first interconnect plugs 20 together constituting the conductive lead-out structure. The electro-optic modulator obtained from the preparation method for an electro-optic modulator of this embodiment is shown in FIG. 13.

Continuing to refer to FIG. 13, the third embodiment provides another electro-optic modulator. The specific structure of the electro-optic modulator of the third embodiment is largely the same as the specific structure of the electro-optic modulator of the first embodiment, except for the conductive lead-out structure. The conductive lead-out structure in the third embodiment includes: backside electrodes 21, the backside electrodes 21 being located on a surface of the second dielectric layer 19 remote from the covering dielectric layer 12; and first interconnect plugs 20, each interconnect plug 20 having one end connected to the corresponding backside electrode 21 and another end connected to the corresponding metal electrode 13.

### Embodiment 4

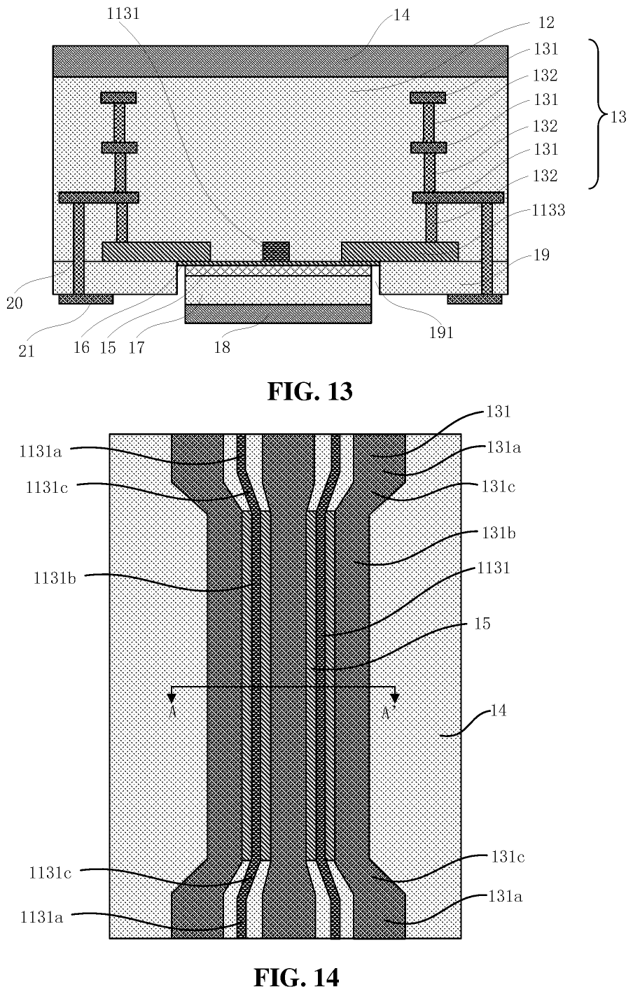

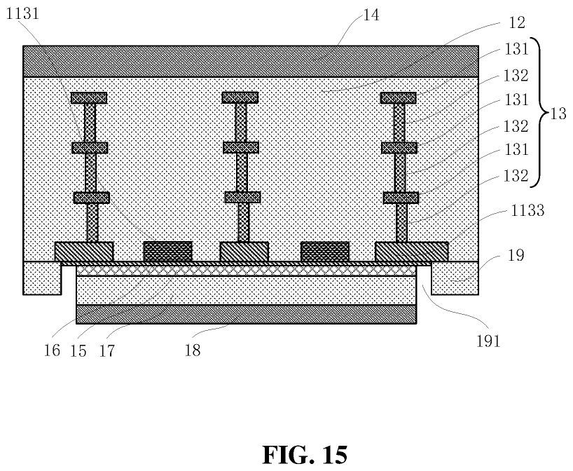

FIG. 14 is a top-view schematic structural diagram of an electro-optic modulator resulting from a preparation method according to a fourth embodiment of the present disclosure. FIG. 15 is a sectional-view schematic structural diagram along an A-A′ line direction in FIG. 14. Referring to FIGS. 14 and 15 in conjunction with FIGS. 1 through 9, the fourth embodiment of the present disclosure provides another electro-optic modulator. The specific structure of the electro-optic modulator of the fourth embodiment is largely the same as the specific structure of the electro-optic modulator of the first embodiment, except that: the electro-optic modulator in the first embodiment includes one waveguide 1131, two metal electrodes 13, and two bottom electrodes 1133, while the electro-optic modulator in the fourth embodiment includes a plurality of bottom electrodes 1133, a plurality of metal electrodes 13, and a plurality of waveguides 1131. In the electro-optic modulator of the fourth embodiment, the waveguides 1131 are located between the metal electrodes 13 that are adjacent to each other. Projections of all of the waveguides 1131 onto a plane in which the lithium niobate thin film 15 is located are on a surface of the lithium niobate thin film 15 facing the covering dielectric layer 12. In other words, the waveguides 1131 are located directly above the lithium niobate thin film 15.

According to an embodiment, and as shown in FIG. 14, the waveguides 1131 and the metal layers 131 each includes two end straight-line portions 1131a and 131a at two ends, a middle straight-line portion 1131b and 131b in the middle, and two bending portions 1131c and 131c each between an end straight-line portion and middle straight-line portion. The lithium niobate thin film 15 may be located only below the middle straight-line portions of the waveguides 1131 and the middle straight-line portions of the metal layers 131, as shown in FIG. 14.

In the description of the specification, reference to the terms “one embodiment,” “some embodiments,” “other embodiments,” etc. means that a specific feature, a structure, a material, or a characteristic described in conjunction with the embodiment or example is included in at least one embodiment or example of the present disclosure. In the specification, an illustrative description of the above terms does not necessarily refer to the same embodiment or example.

The various technical features of the above-described embodiments may be combined in any manner, and all possible combinations of the technical features of the above-described embodiments have not been described for the sake of conciseness of description; however, as long as there is no incompatibility in the combinations of these technical features, they should be considered to be within the scope of the present specification as recorded herein.

The above-described embodiments, which are described in a more specific and detailed manner, are only several embodiments of the present disclosure, but they are not to be thus construed as to limit the patent scope of the disclosure. It should be noted that, for persons of ordinary skill in the art, a number of variations and improvements may be made without departing from the conception of the present disclosure, all of which fall within the scope of protection of the present disclosure. Therefore, the scope of protection of the patent for the present disclosure shall be defined by the appended claims.

1. A preparation method for an electro-optic modulator, comprising steps of:
providing a base substrate, and forming a waveguide and bottom electrodes on an upper surface of the base substrate, the bottom electrodes being located on two opposite sides of the waveguide and spaced apart from the waveguide;
forming a covering dielectric layer and metal electrodes, the covering dielectric layer being located on the upper surface of the base substrate and covering the waveguide and the bottom electrodes, the metal electrodes being located in the covering dielectric layer and on the bottom electrodes, and the metal electrodes respectively corresponding to, and being connected to, the bottom electrodes;
forming a supporting substrate on an upper surface of the covering dielectric layer;
removing the base substrate; and
providing a lithium niobate thin film and bonding the lithium niobate thin film to a lower surface of the covering dielectric layer remote from the supporting substrate, the lithium niobate thin film being located directly below the waveguide.

2. The preparation method according to claim 1, wherein the step of providing the base substrate and forming the waveguide and the bottom electrodes on the upper surface of the substrate comprises steps of:
providing a silicon-on-insulator (SOI) substrate, the SOI substrate comprising a back substrate, a buried oxide layer, and a top silicon layer stacked in a bottom-to-top order;
etching the top silicon layer of the SOI substrate to form the waveguide and initial bottom electrodes, the buried oxide layer and the back substrate together constituting the base substrate; and
doping the initial bottom electrodes to form the bottom electrodes, the bottom electrode being heavily doped silicon electrodes.

3. The preparation method according to claim 2, wherein the step of providing the lithium niobate thin film and bonding the lithium niobate thin film to the lower surface of the covering dielectric layer remote from the supporting substrate comprises steps of:
providing a bonding substrate, the bonding substrate having a first dielectric layer formed thereon;
forming the lithium niobate thin film on an upper surface of the first dielectric layer; and
bonding the lithium niobate thin film to the lower surface of the covering dielectric layer remote from the supporting substrate via a bonding layer.

4. The preparation method according to claim 3, wherein the bonding layer comprises a benzocyclobutene (BCB) layer.

5. The preparation method according to claim 1, wherein, before the step of providing the lithium niobate thin film and bonding the lithium niobate thin film to the lower surface of the covering dielectric layer remote from the supporting substrate, the preparation method further comprises steps of:
forming a second dielectric layer and a conductive lead-out structure, the second dielectric layer being located on the lower surface of the covering dielectric layer remote from the supporting substrate, the conductive lead-out structure being connected to the metal electrodes to electrically lead the metal electrodes out, the second dielectric layer having a first opening, the first opening exposing the waveguide, portions of the bottom electrodes, and a portion of the lower surface of the covering dielectric layer;
the lithium niobate thin film being bonded to the lower surface of the covering dielectric layer exposed by the first opening remote from the supporting substrate.

6. The preparation method according to claim 5, wherein the step of forming the second dielectric layer and the conductive lead-out structure comprises steps of:
forming the second dielectric layer on the exposed lower surface of the covering dielectric layer remote from the supporting substrate, forming interconnect holes in the second dielectric layer and the covering dielectric layer, the interconnect holes respectively corresponding to, and exposing, the metal electrodes;
forming first interconnect plugs in respectively corresponding interconnect holes, each first interconnect plug having one end connected to a corresponding metal electrode; and
forming backside electrodes on a surface of the second dielectric layer remote from the covering dielectric layer, the backside electrodes respectively corresponding to, and being connected to, the first interconnect plugs, the backside electrodes and the first interconnect plugs together constituting the conductive lead-out structure.

7. The preparation method according to claim 5, wherein the step of forming the second dielectric layer and the conductive lead-out structure comprises steps of:
forming the second dielectric layer on the exposed lower surface of the covering dielectric layer remote from the supporting substrate, forming first interconnect plugs in the second dielectric layer and the covering dielectric layer, and forming backside electrodes in the second dielectric layer, the first interconnect plugs respectively corresponding to the metal electrodes, the backside electrodes respectively corresponding to the first interconnect plugs, each of the first interconnect plugs having one end connected to a corresponding metal electrode and another end connected to a corresponding backside electrode, the backside electrodes and the first interconnect plugs together constituting the conductive lead-out structure; and
forming the first opening and second openings in the second dielectric layer, the second openings respectively corresponding to, and exposing, the backside electrodes.

8. The preparation method according to claim 7, wherein each of the backside electrodes comprises a plurality of backside electrode metal layers and a plurality of second interconnect plugs, the backside electrode metal layers that are adjacent are connected by the second interconnect plugs, each second opening exposes a backside electrode metal layer located at a bottom of a corresponding backside electrode, and any of the backside electrode metal layers in one of the backside electrodes is connected to a corresponding metal electrode by one of the first interconnect plugs.

9. An electro-optic modulator, comprising:
a lithium niobate thin film;
a covering dielectric layer located on the lithium niobate thin film;
a waveguide located in the covering dielectric layer and directly above the lithium niobate thin film;
bottom electrodes located in the covering dielectric layer and on two opposite sides of the waveguide and spaced apart from the waveguide; and
metal electrodes located in the covering dielectric layer, the metal electrodes respectively corresponding to the bottom electrodes, and the metal electrodes being located on, and connected to, the respectively corresponding bottom electrodes.

10. The electro-optic modulator according to claim 9, further comprising:
a supporting substrate located on a surface of the covering dielectric layer remote from the lithium niobate thin film;
a first dielectric layer located on a surface of the lithium niobate thin film remote from the covering dielectric layer; and
a bonding substrate located on a surface of the first dielectric layer remote from the lithium niobate thin film.

11. The electro-optic modulator according to claim 10, further comprising:
a second dielectric layer located on the surface of the covering dielectric layer remote from the supporting substrate, the second dielectric layer having a first opening, the first opening exposing the waveguide, portions of the bottom electrodes, and a portion of the covering dielectric layer, and the lithium niobate thin film being located in the first opening.

12. The electro-optic modulator according to claim 11, wherein the lithium niobate thin film and the covering dielectric layer are combined together by way of bonding.

13. The electro-optic modulator according to claim 11, wherein a bonding layer that bonds together the lithium niobate thin film and the covering dielectric layer is disposed between the lithium niobate thin film and the covering dielectric layer.

14. The electro-optic modulator according to claim 11, further comprising backside electrodes disposed on a surface of the second dielectric layer remote from the covering dielectric layer, the backside electrodes respectively corresponding to the metal electrodes, and the backside electrodes being electrically connected to the respectively corresponding metal electrode.

15. The electro-optic modulator according to claim 9, further comprising a plurality of the bottom electrodes, a plurality of the metal electrodes, and a plurality of the waveguides, the waveguides being located between the metal electrodes that are adjacent, and projections of all of the waveguides onto a plane in which the lithium niobate thin film is located are on a surface of the lithium niobate thin film facing the covering dielectric layer.
